(19) United States
(12) Patent Application Publication
(10) Pub. No.: US 2010/0153142 A1
(43) Pub. Date: Jun. 17, 2010

(54) GROUP DECISION MAKING FOR TICKET PURCHASES

(75) Inventors: Venugopal Vasudevan, Palatine, IL (US); William L. Olson, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/334,690

(22) Filed: Dec. 15, 2008

(51) Int. Cl. G06Q 10/00

(52) U.S. Cl. 705/5

(57) ABSTRACT

Disclosed is a group decision-making process. One user (the “control”) is selected to propose a possibility (e.g., a group seating arrangement) to other members of the group. The other members access on-line information to review the proposal and then send their feedback to the control. The proposal is altered as necessary based on the feedback and on any exigencies (e.g., one of the seats in the proposal becomes unavailable to the group). When consensus is reached within the group, the control launches an interaction with the vendor to implement the consensus decision. In this way, every group member has the opportunity to affect the decision based on whatever information, constraints, or preferences seem relevant to that group member. Also, the proposal is always kept up-to-date so that the final decision is not based on “stale” information.

### FIELD OF THE INVENTION

The present invention is related generally to computer techniques for enabling collaboration and, more particularly, to enabling group input in a decision-making process.

### BACKGROUND OF THE INVENTION

Most people have experienced group decision making, wherein individual group members, each with a different set of constraints and personal preferences, try to work together to make a unified decision that affects everyone in the group. Whether the outcome is of the highest importance or is trivial (e.g., whether the decision is how to found a republic or what appetizer to share at dinner), the problems of fully considering the input of all group members and fairly resolving any conflicts within the group have daunted the best conciliators and politicians since time immemorial.

Today, group members can use communication networks to access enormous stores of information that can be of use in driving a group decision. As one example, when a group decides to attend a live event (e.g., a game, a concert, or a theatrical performance), each group member can access information about which seats at the venue are still available, the price assigned to each available seat, and, often, a simulation of the view of the stage from each available seat.

However, the very amount of information available, and the ease with which it can be accessed by anyone from anywhere, can actually make the process of reaching consensus more difficult for group members. In the example given above, the number of combinations of available seats near to one another with good views and acceptable prices can overwhelm the group decision makers. The live aspect of the information exacerbates this situation because the set of available seats changes second by second as other people, not in the group, purchase seats that were under consideration by the group members. In one very real scenario, the group chooses a set of seats but manages to secure only a subset of the chosen seats before the other seats become unavailable. This may cause the group to release the seats it has and to begin the decision-making process all over again, while in the mean time, the enforced delay reduces the seating options available for the group.

### BRIEF SUMMARY

The above considerations, and others, are addressed by the present invention, which can be understood by referring to the specification, drawings, and claims. According to aspects of the present invention, group decision making is supported when one user (the “control”) is selected to propose a possibility (e.g., a group seating arrangement) to other members of the group. The other members access on-line information to review the proposal and then send their feedback to the control. The proposal is altered as necessary based on the feedback and on any exigencies (e.g., one of the seats in the proposal becomes unavailable to the group). When consensus is reached within the group, the control launches an interaction with the vendor to implement the consensus decision. In this way, every group member has the opportunity to affect the decision based on whatever information, constraints, or preferences seem relevant to that group member. Also, the proposal is always kept up-to-date so that the final decision is not based on “stale” information.

In some embodiments, the group decision-making process is supported by personal communication devices operated by the group members. The control's device, at least, accesses the vendor's on-line information. Via a data session, the device of each non-control group member receives the updated proposal from the control and displays it for its user. The received proposal can include, for example, prices of each seat and a view (archived or synthetic still images or video) from each seat. In some embodiments, each user accesses on-line information to help in evaluating the proposal. After reviewing the proposal, each user can send feedback from his device to control's device. Upon reaching consensus, the control purchases the seats for all group members in a single, unified transaction with the vendor.

Some embodiments support a voice connection (e.g., a conference call) among all of the group members to allow them to discuss the proposal at the same time that they can view the proposal on their personal communication devices.

Some vendor's on-line purchasing systems allow a potential purchase to be “held” for a small amount of time (typically, a minute or less) while the purchaser is deciding whether to confirm the purchase or to release it. In these situations, when the control believes that consensus is near, he can hold the current proposal with the vendor and take a vote among the group members. This decreases the chance that the proposal being voted on will go “stale” during the voting process.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIGS. 2a and 2b are simplified schematics of a personal communication device that supports group decision making for ticket purchases; and

FIG. 3 is a flowchart of an exemplary method for making a group ticket purchase.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

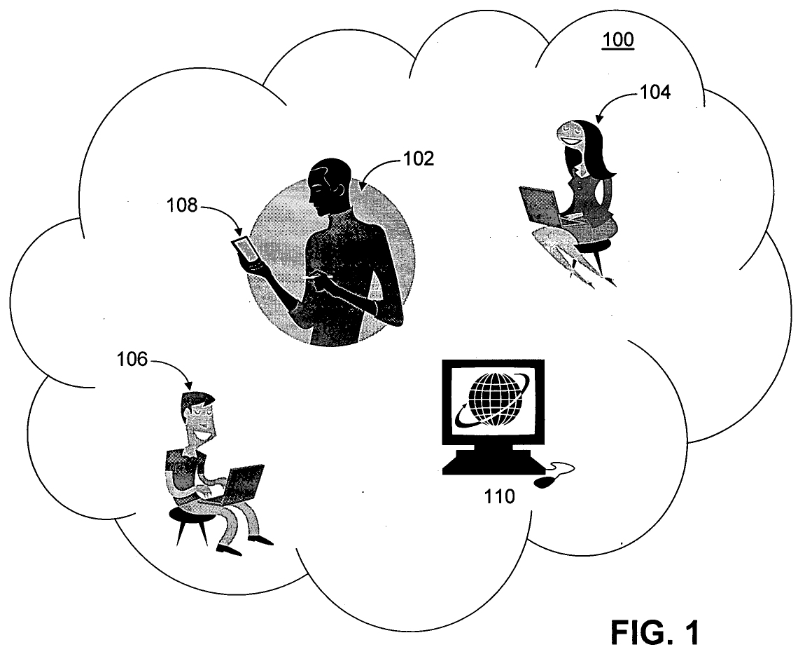

In FIG. 1, the members 102, 104, 106 of a group would like to buy tickets to an event together. Each group member 102, 104, 106 may have unique seating and pricing preferences for the event. The group members 102, 104, 106 are in contact with one another, either by local presence or through a communication network 100. At least some of the group members 102, 104, 106 have access to personal communication devices 108. Through a personal communication device 108, a group member has access to a server 110 that provides information from the event's vendor about seating choices and prices.

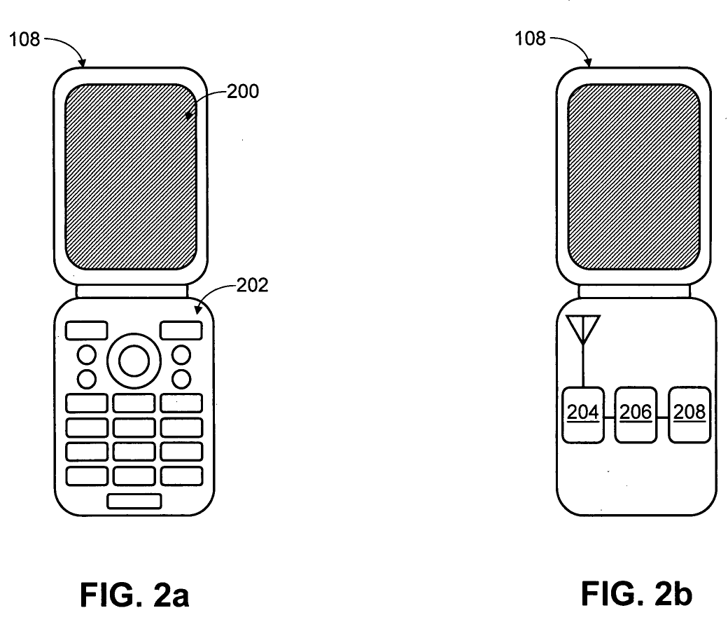

FIGS. 2a and 2b show a representative personal communication device 108 (e.g., a cellular telephone, personal digital assistant, or personal computer). In FIGS. 2a and 2b, the device 108 is shown as a cellular telephone in an open configuration, presenting its main display screen 200 to a group member. Typically, the main display 200 is used for most high-fidelity interactions with the group member. For example, the main display 200 is used to show video or still images, is part of a user interface for changing configuration settings, and is used for viewing call logs and contact lists. To support these interactions, the main display 200 is of high resolution and is as large as can be comfortably accommodated in the device 108. A device 108 may have a second and possibly a third display screen for presenting status messages. These screens are generally smaller than the main display screen 200. They can be safely ignored for the remainder of the present discussion.

The typical user interface of the personal communication device 108 includes, in addition to the main display screen 200, a keypad 202 or other user-input devices.

FIG. 2b illustrates some of the more important internal components of the personal communication device 108. The device 108 includes a communications transceiver 204, a processor 206, and a memory 208.

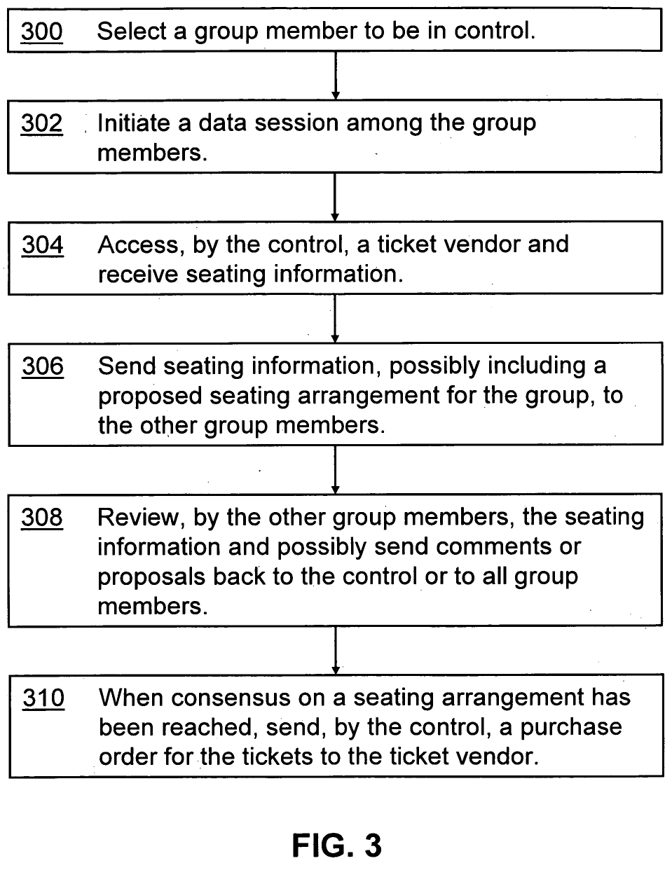

FIG. 3 presents one method for allowing the group members 102, 104, 106 to collaborate in deciding which tickets to purchase for the event. The method begins in step 300 when a member of the group is chosen to be in “control” of the group decision-making process. The choice can be made in person or through the data session initiated in step 302 among the group members 102, 104, 106. In the later case, of course, step 302 precedes step 300.

In step 304, the control 102 uses his personal communication device 108 to access the ticket server 110. The control 102 requests and receives whatever seating information is provided by the ticket server 110. For example, a simple ticket server 110 may only provide a list of seats still available and the price for each seat. A slightly more helpful ticket server 110 provides a map showing the locations of the available seats. A sophisticated ticket server 110 can provide a view of the event stage from each available seat. The view may be a still image or video. The view can be recorded, synthetic, or even a live feed. A very sophisticated ticket server 110 can even provide a full 360 degree navigable view from each available seat.

In any case, in step 306 the control 102 sends whatever seating information he has received to the other group members 104, 106. He may also send a proposed seating arrangement, consisting of seats currently available, to the other group members 104, 106. In some embodiments, the control 102 reserves the seats in the proposed seating arrangement. Because many event vendors only allow seats to be reserved for a very short time (e.g., a minute) before the seats are purchased or released, the control 102 can send a count-down timer along with the proposed seating arrangement.

In step 308, each participating group member 104, 106 receives the seating information from the control 102 and displays that information on a local personal communication device 108. The group members 104, 106 review the information, possibly looking through the views from the available seats, running a navigation application that runs the 360 degree viewer, and considering the pricing of various seats. Each group member 102, 104, 106 can display a map that shows the locations of all of the seats in the proposed arrangement. The group members 104, 106 can then send their feedback either only to the control 102 or to all members of the group.

To facilitate the group decision-making process, in some embodiments the group members 102, 104, 106 can set up a voice session and discuss possible seating arrangements. They can also choose another group member to be in control.

The control 102 considers all the feedback, makes appropriate changes to the proposed seating arrangement, and sends a new proposal to the group members 104, 106. During the discussion process, a proposal can be invalidated when seats originally available become unavailable as they are purchased by others not in the group. (This assumes that the seats were not reserved during the discussion process.) This information is transmitted by the ticket server 110 to the control 102. The new seating proposals take account of these changes.

In step 310, the group members 102, 104, 106 eventually reach consensus on a proposed seating arrangement. The control 102 then purchases the seats from the ticket server 110.

Through the control 102 acting as a single point-of-contact with the ticket server 110, the group can make a single purchase order for seats for the entire group. This prevents the common situation where a group makes a decision but is only able to purchase some of the chosen seats before others of the chosen seats become unavailable. Thus, the methods of the present invention not only allow the group members to interact to reach a consensus, they enable the group members to more easily act on that consensus.

In view of the many possible embodiments to which the principles of the present invention may be applied, it should be recognized that the embodiments described herein with respect to the drawing figures are meant to be illustrative only and should not be taken as limiting the scope of the invention. For example, different user interfaces may be appropriate to different events and may depend upon the type of information made available by the event vendor. Therefore, the invention as described herein contemplates all such embodiments as may come within the scope of the following claims and equivalents thereof.

We claim:

1. A method for participating in a group decision about purchasing tickets for an event, each person in the group having access to a personal communication device, the method comprising:
selecting one person in the group to be in control;
initiating a data session with others in the group;
accessing, by a personal communication device of the person in control, a seller of tickets for the event;
sending, by the personal communication device of the person in control to others in the group, a proposed seating arrangement;
receiving, by the personal communication device of the person in control, responses about the proposed seating arrangement from others in the group; and
based, at least in part, on the received responses, purchasing tickets for the event.

2. The method of claim 1 further comprising:
communicating among personal communication devices in the group to select another person in the group to be in control.

3. The method of claim 1 further comprising:
sending, to each personal communication device in the group, a view from a proposed seat, the view selected from the group consisting of: an archived image, an archived video, a synthetic image, and a synthetic video.

4. The method of claim 1 further comprising:
sending, to each personal communication device in the group, a stereoview from a proposed seat and an ability to navigate to obtain a 360 degree view from the proposed seat.

5. The method of claim 1 further comprising:
sending, to each personal communication device in the group, a price of a proposed seat.

6. The method of claim 1 further comprising:
initiating a voice session with people in the group.

7. A personal communication device configured for participating in a group decision about purchasing tickets for an event, the device comprising:
a transceiver for communicating via a data session with others in the group and for accessing a seller of tickets for the event; and
a processor operatively connected to the transceiver and configured for initiating a data session with others in the group, for sending, to others in the group, a proposed seating arrangement, for receiving responses about the proposed seating arrangement from others in the group; and based, at least in part, on the received responses, for purchasing tickets for the event.

8. The device of claim 7 wherein the processor is further configured for:
communicating among personal communication devices in the group to select a person in the group to be in control.

9. The device of claim 7 wherein the transceiver is further configured for:
sending, to another in the group, a view from a proposed seat, the view selected from the group consisting of: an archived image, an archived video, a synthetic image, and a synthetic video.

10. The device of claim 7 wherein the transceiver is further configured for:
sending, to another in the group, a price of a proposed seat.

11. The device of claim 7 wherein the processor is further configured for:
initiating a voice session with others in the group.

12. A method for participating in a group decision about purchasing tickets for an event, each person in the group having access to a personal communication device, the method comprising:
selecting one person in the group to be in control;
participating in a data session with others in the group;
receiving, from a personal communication device of the person in control, a proposed seating arrangement; and
sending, to the personal communication device of the person in control, a response about the proposed seating arrangement.

13. The method of claim 12 further comprising:
communicating among personal communication devices in the group to select another person in the group to be in control.

14. The method of claim 12 further comprising:
receiving a view from a proposed seat, the view selected from the group consisting of: an archived image, an archived video, a synthetic image, and a synthetic video.

15. The method of claim 12 further comprising:
receiving a stereoview from a proposed seat and an ability to navigate to obtain a 360 degree view from the proposed seat.

16. The method of claim 12 further comprising:
receiving a price of a proposed seat.

17. The method of claim 12 further comprising:
participating in a voice session with people in the group.

18. A personal communication device configured for participating in a group decision about purchasing tickets for an event, the device comprising:
a transceiver for communicating via a data session with others in the group; and
a processor operatively connected to the transceiver and configured for participating in a data session with others in the group, for receiving a proposed seating arrangement, and for sending, to the personal communication device of the person in control, a response about the proposed seating arrangement.

19. The device of claim 18 wherein the processor is further configured for:
communicating among personal communication devices in the group to select a person in the group to be in control.

20. The device of claim 18 wherein the transceiver is further configured for:
receiving a view from a proposed seat, the view selected from the group consisting of: an archived image, an archived video, a synthetic image, and a synthetic video.

21. The device of claim 18 wherein the transceiver is further configured for:
receiving a price of a proposed seat.

22. The device of claim 18 wherein the processor is further configured for:
participating in a voice session with others in the group.
